(19) United States
(12) Patent Application Publication
(10) Pub. No.: US 2004/0200125 A1
(43) Pub. Date: Oct. 14, 2004

(54) Vibrating fishing lure

(76) Inventors: Thomas K. Albanito, Trevor, WI (US); Raymond R. Walls JR., McHenry, IL (US)

Correspondence Address: Lesavich High-Tech Law Group, P.C., Suite 325, 39 S. LaSalle Street, Chicago, IL, 60603, US

(21) Appl. No.: 10/811,711

(22) Filed: Mar. 29, 2004

Related U.S. Application Data
(60) Provisional application No. 60/458,237, filed on Mar. 31, 2003.

(51) Int. Cl. A01K 79/02

(52) U.S. Cl. 43/42.36; 43/42

(57) ABSTRACT

A vibrating fishing lure. The vibrating fishing lure includes a pre-programmed microprocessor that is pre-programmed to effect an intermittent operation of the vibrator to effect an intermittent movement of the a lure body component to simulate a healthy, dying or distressed organism used to attract and catch fish.

### CROSS REFERENCES TO RELATED APPLICATIONS

This application claims priority to U.S. Provisional Application No. 60/458,237, filed Mar. 31, 2003, the contents of which are incorporated by reference.

### FIELD OF THE INVENTION

This invention relates to fishing lures. More specifically, it relates to a vibrating fishing lure.

### BACKGROUND OF THE INVENTION

Many types of fishing lures have been made including those with multiple articulated body sections, hard bodies with rubber tails, soft molded vinyl bodies, lures with spinners and other attractors, and some with electronic modules that make them “swim.” The more realistic a swimming motion for a swimming lure, the better chance the lure will attract a desired game fish. However, there are several problems with trying to produce a fishing lure that emulates a swimming bait fish.

One problem is that such fishing lures typically do not emulate the action of a real healthy organism. Another problem is that such fishing lures typically do not emulate the action of a real distressed or dying organism. Another problem is that such fishing lures typically include mechanical components subject to failure thus causing frustration for fisherman. Another problems is that such fishing lures are expensive to manufacture and may not purchased by fisherman.

There have been attempts to solve some of the problems associated with fishing lures that move. For example, U.S. Pat. No. 6,457,271, entitled “Electronic Fishing Lure” that issued to Spurgeon teaches an apparatus and method for attracting fish by means of electronic fishing lure having a steel ball enclosed in a metal tube and having a piezoelectric crystal enclosed therewith as one end thereof which generates an electric voltage that is transmitted to the surrounding water when the ball strikes an end of the tube as a result of the motion of the lure in the water oscillating the tube.

U.S. Pat. No. 6,581,319 entitled “Battery Powered Vibrating Fishing Lure” that issued to West teaches A fishing lure that emanates an intermittent sound-producing vibration for attracting fish. The lure comprises a body which simulates a living creature, where a central portion thereof includes a motor mounting an unbalanced weighted shaft to effect the vibration. Further, the motor is controlled by a programmed microprocessor to randomly operate the motor.

U.S. Pat. No. 6,665,976 entitled “Method and Fishing Lure for Producing Oscillatory Movement” that issued to West teaches a fishing lure that oscillates from side to side to provide motion to the fishing lure as way for attracting fish. The lure comprises a body which simulates a living creature, where a central portion thereof includes an intermittently operable motor, and operating in a reversible manner, to achieve the oscillating motion. Further, the motor is controlled by a preprogrammed microprocessor.

U.S. Pat. No. 6,684,556 entitled “Remotely Controlled Vibrating Fishing Bait” that issued to Arbuckle et al. teaches A remotely controlled vibrating fishing lure. The lure has a body, a transmitter, a receiver, and a battery operated vibration member controlled by the receiver. The vibrating member may be contained in a fluid tight chamber in the lure body or placed in a housing adjacent the lure body. The transmitter is operable to selectively transmit an electromagnetic radio signal to the receiver to selectively vibrate the fishing lure. A conventional transmitter and receiver may be used, and the vibration member can be of the type traditionally used in telecommunications paging systems. The lure is adapted to float or the receiver antenna is provided with a bobber or other means to retain a portion of the antenna above the water.

However, these attempts still do not solve all of the problems associated with providing fishing lures with simulated swimming motions. Thus, it is desirable to produce a fishing lure that provides a simulated swimming motion for both healthy and distress fish.

### SUMMARY OF THE INVENTION

In accordance with preferred embodiments of the invention, some of the problems associated with fishing lures are overcome. A vibrating fishing lure is presented.

The vibrating fishing lure may better attract and catch fish when used for fishing.

The foregoing and other features and advantages of preferred embodiments of the invention will be more readily apparent from the following detailed description. The detailed description proceeds with references to the accompanying drawings.

### BRIEF DESCRIPTION OF THE DRAWINGS

Preferred embodiments of the invention are described with reference to the following drawings, wherein:

FIG. 1 is a block diagram illustrating a vibrating fishing lure;

FIG. 2 is a block diagram illustrating additional details of an electronic circuit board;

FIG. 3 is a block diagram illustrating additional details of the electronic circuit board;

FIG. 4 is a block diagram illustrating a lure body component with the vibrating fishing lure contained therein; and

FIG. 5 is a block diagram of a vibrating fishing lure further illustrating the components contained therein.

### DETAILED DESCRIPTION OF PREFERRED EMBODIMENTS

Exemplary Vibrating Fishing Lure

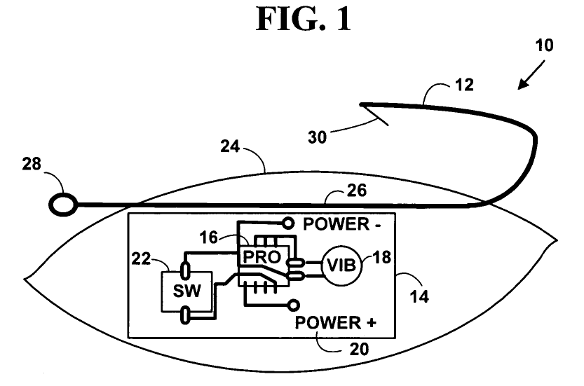

FIG. 1 is a block diagram illustrating a vibrating fishing lure 10. The vibrating fishing lure 10 includes, but is not limited to, a hooking means 12, an electronic circuit board 14 with a pre-programmed microprocessor 16 and a vibrator 18 integral thereto configured for effecting an intermittent movement of a lure body component. The pre-programmed microprocessor 16 is pre-programmed to effect an intermittent operation of the vibrator 18 to effect an intermittent movement of a lure body component. The vibrating fishing lure 10 also includes a power source 20 to provide power to the electronic circuit board 16, and an on-off switch 22 for turning the power source 20 on and off.

The vibrating fishing lure 10 further includes a containment component 24 having a first portion 26 of the hooking means 12, the electronic circuit board 14, the power source 20 and the on-off switch 22 contained in a waterproof portion therein. In one embodiment, the containment component 24 includes, but is not limited to, pre-formed slots to accept the first portion 26 of the hooking means 12, the electronic circuit board 14, the power source 22 and the on-off switch 24. In one embodiment of the invention, the containment component 24 is two separate pieces with pre-formed slots that snap together forming a waterproof portion therein. However, the invention is not limited to his embodiment and other types of containment components 24 can also be used.

A second portion 28 of the hooking means 12 as a connection portion protrudes outside the containment component 24 and a third portion 30 of the hooking means 12 protrudes as a hooking portion.

An operating environment for the components of the vibrating fishing lure 10 include a processing system with one or more high speed Central Processing Unit(s) (“CPU”), processors and one or more memories. In accordance with the practices of persons skilled in the art of computer programming, the invention is described below with reference to acts and symbolic representations of operations or instructions that are performed by the processing system, unless indicated otherwise. Such acts and operations or instructions are referred to as being “computer-executed,” “CPU-executed,” or “processor-executed.”

It will be appreciated that acts and symbolically represented operations or instructions include the manipulation of electrical signals or biological signals by the CPU or processor. An electrical system or biological system represents data bits which cause a resulting transformation or reduction of the electrical signals or biological signals, and the maintenance of data bits at memory locations in a memory system to thereby reconfigure or otherwise alter the CPU's or processor's operation, as well as other processing of signals. The memory locations where data bits are maintained are physical locations that have particular electrical, magnetic, optical, or organic properties corresponding to the data bits.

The data bits may also be maintained on a computer readable medium including magnetic disks, optical disks, organic memory, and any other volatile (e.g., RAM) or non-volatile (e.g., Read-Only Memory (“ROM”), flash memory, etc.) mass storage system readable by the CPU. The computer readable medium includes cooperating or interconnected computer readable medium, which exist exclusively on the processing system or can be distributed among multiple interconnected processing systems that may be local or remote to the processing system.

In FIG. 1, the hooking means 12 is illustrated as a single hook with a single hooking portion 30. However, the hooking means 12 hooking means also includes a single hook with a carabineer mechanism to prevent snagging in weedy areas, a single hook with plural hooking portions (e.g., a treble hook) or plural hooks.

In one embodiment of the invention, the hooking means 12 is not connected to the electronic circuit 14. In another embodiment of the invention, the hooking means 12 is connected to the electronic circuit 14 and receives a small electronic current from the electronic circuit 14. The hooking means 12 provides resistance to the electronic current and produces heat and an electrical field. The electronic current and/or the heat produced from the resistance aids in the attraction of fish via the hooking means 12. This embodiment may be especially effective in salt water where selected game fish are known to be attracted via electrical currents and/or electrical fields.

However, the invention is not limited to the hooking means described and other hooking means 12 can also be used to practice the invention.

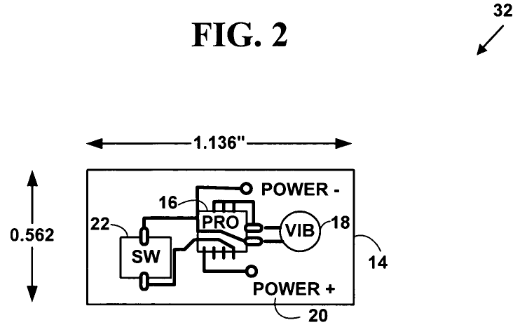

FIG. 2 is a block diagram 32 illustrating additional details of the electronic circuit board 14. In one embodiment of the invention, the electronic circuit board 14 has a length of about 1.136 inches and a height of about 0.562 inches and a width of about 0.25 inches. However, the invention is not limited to the dimension described and electronic circuit boards of other dimensions can also be used to practice the invention.

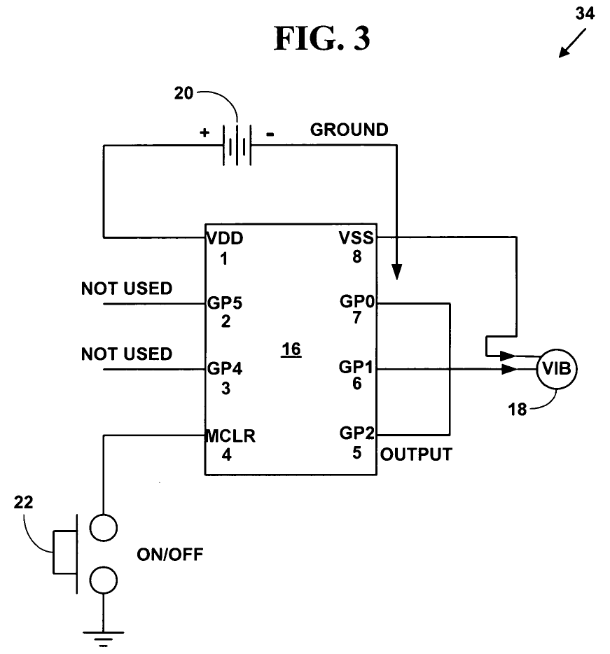

FIG. 3 is a block diagram 34 illustrating additional details of the electronic circuit board 14. In one embodiment of the invention, the pre-programmed microprocessor 16 includes, but is not limited to, a PIC 12C508A microcontroller by MicroChip of Chandler, Ariz. This microcontroller has a length of about 0.325 inches including the pins, a width of about 0.210 inches and a height of about 0.079 inches. This microcontroller is an 8-pin, 8-bit Reduced Instruction Set Computer (RISC) central processing unit (CPU) with 512 words of Electrically Erasable Programmable Read-Only Memory (EEPROM) and 25-bytes of data Random Access Memory (RAM).

The pre-programmed microprocessor 16 includes, but is not limited to, a software program written in the native assembly language, or other higher level language for the microprocessor and stored in the non-volatile storage (e.g., EEPROM) included with the microprocessor 16. The microprocessor 16 is pre-programmed to effect an intermittent operation of the vibrator 18 to effect an intermittent movement of the lure body component 38. The vibrator 18 can be used in a forward, reversed, pulsed, or frequency-varying manner to produce the desired intermittent movement by selectively applying the appropriate control from the microprocessor 16.

For example, the microprocessor 16 is pre-programmed to simulate the intermittent swimming of a healthy minnow or other bait fish. The microprocessor 16 may also be pre-programmed to simulate the intermittent swimming of a diseased, injured or dying bait fish. The microprocessor 16 may also be pre-programmed to simulate the intermittent movement of a healthy, diseased, injured or dying mouse, worm, frog, crayfish, etc.

The intermittent movement is produced by applying, removing and/or varying a current to the vibrator 18 for selected periods of time at selected pre-determined intervals to produce the desired intermittent movement. The microprocessor 16 may operate in two or more modes (e.g., healthy, injured, dying, etc.) selectable by the on-off switch 22.

However, the invention is not limited to this embodiment and other types of pre-programmed microprocessors 16 can also be used to practice the invention.

Returning to FIG. 1, in one embodiment of the invention, the vibrator 18 includes, but is not limited to, Vibrator 185228 by Jameco Electronics of Belmont, Calif. This vibrator is 0.55 inches in diameter and is 0.13 inches thick and is a 4500 revolution-per-minute, dual direction three-volt direct current motor with two solder pads. This vibrator that is typically found in small toys, beepers, pagers and mobile phones.

In another embodiment of the invention, the vibrator 18 includes, but is not limited to, Vibrator #1E120 by Sanko Electronic Company of Taichung, Taiwan. This vibrator is 0.55 inches in diameter and 0.135 inches think and is a 4300 revolution-per-minute, dual direction three-volt direct current motor with two solder pads. This vibrator is also typically found in small toys, beepers, pagers and mobile phones.

However, the invention is not limited to this embodiment and other types of vibrators 18 can also be used to practice the invention.

In another embodiment of the invention, the electronic circuit 14 further includes an additional component that is used to release chemical scents into the lure body component. The chemical scents are contained in a reservoir that is activated with an electrical current, thereby releasing chemicals contained in the reservoir. The chemical scents used are any chemical scents known in the art to attract fish and other organisms.

In another embodiment of the invention, the electronic circuit 14 further includes an additional component comprising a light means such as one or more light emitting diode (LED). The light means is turned on and off intermittently via the electronic circuit 14 to attract fish.

In another embodiment of the invention, the electronic circuit 14 further includes an additional component comprising a sound means. The sound means includes a speaker, bell, two or more small metal balls, or other means to generate sound to attract fish.

In another embodiment of the invention, the electronic circuit 14 further includes an additional component comprising a magnet to attract fish.

The power source 20 includes, but is not limited to, one or more batteries, a solar cell, capacitor or ambient radio waves. In one embodiment of the invention, the power source 20 includes one or more three-volt batteries that would be used in a wrist-watch, a hearing aid or other small device. The one or more three-volt batteries are used to provide a direct current (DC) to provide power to the components of the electronic circuit board 16. In another embodiment of the invention, the power source 20 is a capacitor that would be charged with an external device such as an electrical-mechanical pump. In another embodiment, the power source 20 is ambient radio waves pick-up from radio stations with an integral antenna.

However, the invention is not limited to this embodiment and other types of power sources 20 can also be used to practice the invention.

The on-off switch 22 is used to the turn the power source 20 on and off and switch between operating modes. The power source 20 is turned on when the vibrating fishing lure 10 is being used and is turned off when the vibrating lure is not being used.

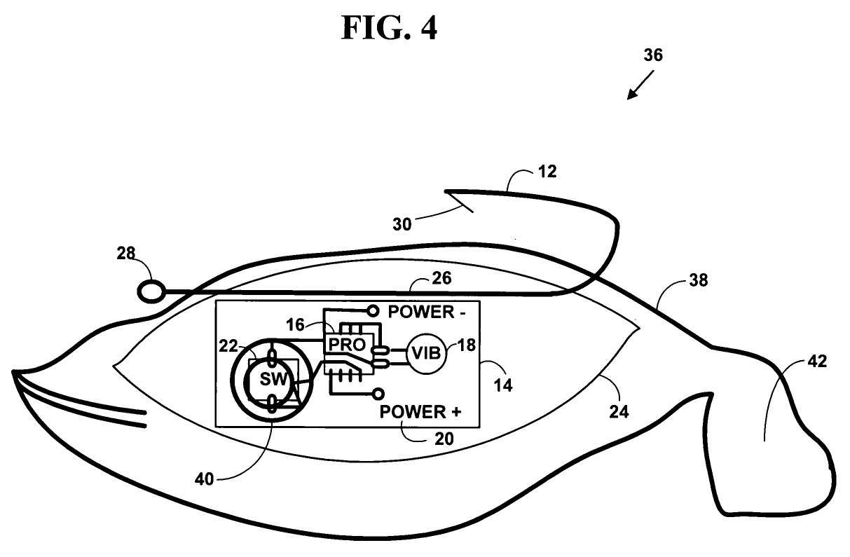

The on-off switch 22 includes, but is not limited to, a toggle switch, push switch, a compression switch, an optical switch, an infrared switch, Bluetooth or a wireless switch. In one embodiment of the invention, the on-off switch 22 is a compression switch that is placed beneath an “eye” of a bait fish or other organism that is being used for the lure body component (See FIG. 4). However, the present invention is not limited to such an embodiment and other embodiments can also used.

The switch 22 is turned on by compressing the switch once. The switch 22 is turned off by pressing the switch again. The switch 22 may be pressed multiple times to effect an intermittent operation of the vibrator 18. For example, the switch 22 may be pressed three-times in rapid succession to simulate intermittent movement of a healthy organism, four-times in rapid succession to simulate intermittent movement of a diseased organism, etc.

In another embodiment of the invention, an optical, infrared, Bluetooth or wireless switch 22 is used (e.g., placed in an “eye” of bait fish or other organism that is being used for the lure body component). However, the invention is not limited to the switches described and other switches can also be used to practice the invention.

In another embodiment of the invention, the on-off switch 22 is an infrared switch, Bluetooth switch, or wireless switch that may configured and turned off with an external device such as controller supplied with the lure, a key-fob or other switched device used to open doors in an automobile, a personal digital assistant (PDA), a mobile phone or other electronic device capable of sending and receiving infrared, Bluetooth or wireless information.

As is known in the art, infrared is used for synchronizing and transmitting data via infrared light waves and is used to provide one type of short-range wireless connection.

As is known in the art, Bluetooth is a short-range radio frequency technology aimed at simplifying communications among devices. Bluetooth wireless technology supports both short-range connections. The Bluetooth specification, version 1.0, 1999, is incorporated by reference. Bluetooth Forum documents can be found on the Internet at the Universal Resource Locator (URL) “www.bluetooth.com.” In another embodiment of the invention, the Bluetooth component can be replaced with virtually any other short-range radio interface component.

In another embodiment of the invention, the wireless switches include but are not limited to, IEEE 802.11a, 802.11b, 802.11g, “Wireless Fidelity” (Wi-Fi), “Worldwide Interoperability for Microwave Access” (WiMAX), “RF Home” or “WAP” wireless switches.

As is known in the art, an 802.11b is a short-range wireless network protocol. The IEEE 802.11b standard defines wireless interfaces that provide up to 11 Mbps wireless data transmission to and from wireless devices over short ranges. 802.11a is an extension of the 802.11b and can deliver speeds up to 54 M bps. 802.11g deliver speeds on par with 802.11a and provides 20+ Mbps in the 2.4 GHz band. However, other 802.11xx switches can also be used and the invention is not limited to the 802.11 protocols defined. The IEEE 802.11a, 802.11b and 802.11g standards are incorporated herein by reference.

As is known in the art, Wi-Fi is a type of 802.11xx interface, whether 802.11b, 802.11a, dual-band, etc. Wi-Fi devices include an RF interfaces such as 2.4 GHz for 802.11b or 802.11g and 5 GHz for 802.11a. More information on Wi-Fi can be found at the URL “www.weca.net.”

As is known in the art, WiMAX uses the IEEE 802.16a standard for wide-area broadband access. WiMAX networks have a range of up to about 30 miles with data transfer speeds of up to about 70 Mpbs. The IEEE 802.16a standard is incorporated herein by reference. More information on WiMAX can be found at the URL “wimaxforum.org.”

As is known in the art, “RF Home” is a standard for wireless networking access devices to both local content and the Internet for voice, data and streaming media in home environments. More information on RF Home can be found at the URL “www.homerf.org.”

RF Home includes the Shared Wireless Access Protocol (“SWAP”). The SWAP specification defines a new common interface protocol that supports wireless voice and data networking in the home. The RF Home SWAP protocol specification, March 1998, is incorporated herein, by reference.

As is known in the art, the Wireless Application Protocol (WAP) is a communications protocol and application environment for wireless network devices. Wireless Transaction Protocol (WTP) that provides reliable transport for the WAP datagram service and is designed to work with most wireless network infrastructures. The WAP Wireless Application Protocol Architecture Specification, WAP-210-WAPArch-20010712-a and the Wireless Application Environment Specification WAP-236-WAESpec-20020207-a are incorporated herein by reference.

However, the invention is not limited to such embodiments and other 802.11xx wireless switches and other types of wireless switches can also be used.

In addition, the invention is not limited to this embodiment and other types of on-off switches 22 can also be used to practice the invention.

The containment component 24 includes, but is not limited to, a plastic, silicon, rubber, fiberglass, composite, metal or wood material. In one embodiment of the invention, the containment component 24 is two separate rigid pieces with pre-formed slots for the lure components that snap together forming a waterproof portion therein. The containment component 24 may also include pre-drilled holes to engage lure components. For example, the containment component may include pre-drilled holes to engage the on/off switch 22. However, the invention is not limited to this embodiment and more, fewer or other types of containment components can also be used to practice the invention.

The containment component 24 is adhered to and contained within a lure body component 38 (e.g., adhered with an adhesive such as glue, adhered with heat, etc.). The lure body component 38 includes, but is not limited to, plastic, silicon, rubber, fiberglass, a composite material or wood is produced to allow the vibrating fishing lure 10 to either immediately float on the surface of sink below of the surface of a body of water. Since the containment component 24 is adhered to the lure body component 38, the vibrator 18 causes the lure body component 38 to move in accordance with signals sent to the vibrator 18 from the pre-programmed microprocessor 16 via a vibration applied to the containment component 24.

The lure body component 38 may also include integral foil, holograms, glitter or other shiny means that will reflect light attract fish. The lure body component 38 may also include one or more metal balls that hit together to cause a sound when the vibrator 18 is activated to attract fish. The lure body component may also include colors typical of the organism being used to attract fish (e.g., the natural coloring of a bait fish such as a minnow).

FIG. 4 is a block diagram 36 illustrating a lure body component 38 with the vibrating fishing lure 10 contained therein. In FIG. 4, the lure body component 38 is illustrated in the shape of a bait fish such as a minnow, chub, etc. The “eye” 40 of the bait fish of the lure body component 38 is placed over the on/off switch 22. However, the invention is not limited to such an embodiment and the lure body component 38 also can be produced in the shape of a worm, crayfish, mouse, frog, snake, bird or virtually any other organism that would be used to catch fish in fresh or salt water.

In one embodiment of the invention, the lure body component 38 includes, but is not limited to, one or more appendages that are attached to and extend beyond the lure body component. The one or more appendages include a tail appendage 42, a claw appendage or one or more leg appendages that represent the organism being used to catch fish (e.g., minnow, crayfish, etc.).

In one embodiment, the lure body component 38 includes, but is not limited to, a one-piece body component. In another embodiment of the invention, the lure body component 38 includes, but is not limited to, a multiple-piece body component (i.e., two or more pieces).

In one embodiment of the invention, the lure body component 38 includes, but is not limited to, a floating means such as a small air-filled bladder, buoyant material such as plastic, cork, etc. or other floating means that allows the lure body component 38 to float in water.

In another embodiment of the invention, the lure body component 38 includes, but is not limited to, a sinking means such as a small ball of metal (e.g., lead, steel, iron, copper, etc.) or other heavy material that causes the lure body component 38 to sink in water.

In another embodiment of the invention, the lure body component 38 includes, but is not limited, to an off-balance weighting or floating means that is used to allow the lure body component 38 to float or sink on its side or back portion, further simulating a distressed or dying organism.

In another embodiment of the invention, the lure body component 38 includes, but is not limited to, plural electrical-conducting filaments (e.g., copper, iron, silicon, composite materials, nanowires, nanotubes, etc.) connected to the electrical circuit 14 that produces heat and raises a temperature of the lure body component 38 to simulate a body temperature of an organism being used to catch fish.

In another embodiment of the invention, the lure body component 38 includes but is not limited to, plural heat removing filaments that absorbs heat (e.g., from the water) and lowers a temperature of the lure body component 38 to simulate a body temperature of an organism being used to catch fish. In one embodiment of the invention, the plural heat removing filaments are connected to the electrical circuit 14. In another embodiment of the present invention, the plural heat removing filaments are not connected to the electrical circuit.

However, the invention is not limited to this embodiment and other types of lure body components can also be used to practice the invention.

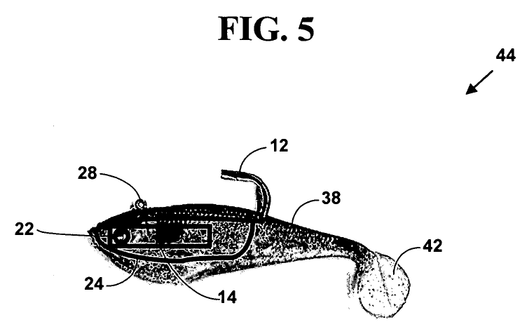

FIG. 5 is a block diagram 44 of vibrating fishing lure 10 further illustrating lure components contained therein. The vibrating fishing lure 10 provides a mechanism to effect an intermittent movement of a lure body component 38 to simulate a healthy, dying or distressed organism used to attract and catch fish. The components of the vibrating fishing lure 10 are relatively inexpensive and thus can provide a new way to attract and catch fish.

It should be understood that the architecture, programs, processes, methods and systems described herein are not related or limited to any particular type of computer or network system (hardware or software), unless indicated otherwise. Various types of general purpose or specialized computer systems may be used with or perform operations in accordance with the teachings described herein.

In view of the wide variety of embodiments to which the principles of the invention can be applied, it should be understood that the illustrated embodiments are exemplary only, and should not be taken as limiting the scope of the invention. For example, the steps of the flow diagrams may be taken in sequences other than those described, and more or fewer elements may be used in the block diagrams.

While various elements of the preferred embodiments have been described as being implemented in software, in other embodiments hardware or firmware implementations may alternatively be used, and vice-versa.

The claims should not be read as limited to the described order or elements unless stated to that effect. In addition, use of the term “means” in any claim is intended to invoke 35 U.S.C. §112, paragraph 6, and any claim without the word “means” is not so intended. Therefore, all embodiments that come within the scope and spirit of the following claims and equivalents thereto are claimed as the invention.

We clam:

1. A vibrating fishing lure, comprising in combination:
a hooking means;
an electronic circuit board with a pre-programmed microprocessor and a vibrator integral thereto configured for effecting an intermittent movement of a lure body component, wherein the pre-programmed microprocessor is pre-programmed to effect an intermittent operation of the vibrator to effect an intermittent movement of the lure body component;
a power source to provide power to the electronic circuit board;
an on-off switch for turning the power source on and off; and
a containment component having the electronic circuit board, a first portion of the hooking means, the power source and the on-off switch contained in an internal waterproof portion therein, wherein the containment component is adhered to and contained within the lure body component to assist in intermittent movement of the lure body component.

2. The vibrating fishing lure of claim 1 wherein the hooking means includes a hooking means for a single hook with a single hooking portion, a single hook with a carabineer mechanism, a single hook with a plurality of hooking portions or a plurality of hooks.

3. The vibrating fishing lure of claim 1 wherein the power source includes a battery, a solar cell or a capacitor.

4. The vibrating fishing lure of claim 1 wherein the on-off switch includes a toggle switch, a compression switch, a push switch, an optical switch an infrared switch, Bluetooth switch or a wireless switch.

5. The vibrating fish lure of claim 1 wherein the containment component comprises a plastic, silicon, rubber, fiberglass, composite, metal or wood material.

6. The vibrating fish lure of claim 1 wherein the lure body component comprises plastic, silicon, rubber, fiberglass, a composite or wood material.

7. The vibrating fish lure of claim 1 wherein the lure body component includes a bait fish, including a minnow, worm, crayfish, mouse, frog, snake or bird shape.

8. The vibrating fish lure of claim 1 wherein the lure body component includes one or more appendages that are attached to and extend beyond the lure body component.

9. The vibrating fish lure of claim 8 wherein the one or more appendages include a tail appendage, a claw appendage or one or more leg appendages.

10. The vibrating fish lure of claim 1 wherein the lure body component includes a plurality of connected body components.

11. The vibrating fish lure of claim 1 wherein the lure body component includes a floatation means.

12. The vibrating fish lure of claim 1 wherein the lure body component includes a sinking means.

13. The vibrating fish lure of claim 1 wherein the pre-programmed microprocessor is pre-programmed to effect an intermittent operation of the vibrator to effect an intermittent movement of the lure body component to simulate a healthy organism.

14. The vibrating fish lure of claim 1 wherein the pre-programmed microprocessor is pre-programmed to effect an intermittent operation of the vibrator to effect an intermittent movement of the lure body component to simulate of a diseased, distressed or dying organism.

15. A vibrating fishing lure, comprising in combination:
a hooking means in contact with an electronic circuit board, wherein the hooking means receives an electronic current from the electronic circuit board;
an electronic circuit board with a pre-programmed microprocessor and a vibrator integral thereto configured for effecting an intermittent movement of a lure body component, wherein the pre-programmed microprocessor is pre-programmed to effect an intermittent operation of the vibrator to effect an intermittent movement of the lure body component;
a power source to provide power to the electronic circuit board;
an on-off switch for turning the power source on and off; and
a containment component having the electronic circuit board, a first portion of the hooking means, the power source and the on-off switch contained in an internal waterproof portion therein, wherein the containment component is adhered to and contained within the lure body component to assist in intermittent movement of the lure body components and wherein the lure body component includes a plurality of electrical conducting filaments attached to the electronic circuit board for receiving current from the electronic circuit board.

16. The vibrating fishing lure of claim 15 wherein the hooking means includes a hooking means for a single hook with a single hooking portion, a single hook with a carabineer mechanism, a single hook with a plurality of hooking portions or a plurality of hooks.

17. The vibrating fishing lure of claim 15 wherein the power source includes a battery, a solar cell or a capacitor.

18. The vibrating fishing lure of claim 15 wherein the on-off switch includes a toggle switch, a compression switch, a push switch, an optical switch an infrared switch, Bluetooth switch or a wireless switch.

19. The vibrating fish lure of claim 15 wherein the containment component comprises a plastic, silicon, rubber, fiberglass, composite, metal or wood material.

20. The vibrating fish lure of claim 15 wherein the lure body component comprises plastic, silicon, rubber, fiberglass, a composite or wood material.

21. The vibrating fish lure of claim 15 wherein the lure body component includes a bait fish, including a minnow, worm, crayfish, mouse, frog, snake or bird shape.

22. The vibrating fish lure of claim 15 wherein the lure body component includes one or more appendages that are attached to and extend beyond the lure body component.

23. The vibrating fish lure of claim 22 wherein the one or more appendages include a tail appendage, a claw appendage or one or more leg appendages.

24. The vibrating fish lure of claim 15 wherein the lure body component includes a plurality of connected body components.

25. The vibrating fish lure of claim 15 wherein the lure body component includes a floatation means.

26. The vibrating fish lure of Clam 15 wherein the lure body component includes a sinking means.

27. The vibrating fish lure of claim 15 wherein the plurality of electrical conducting filaments produce heat and raise a temperature of the lure body component.

28. The vibrating fish lure of claim 15 wherein the plurality of heat absorbing filaments that absorb heat and lower a temperature of the lure body component.

29. The vibrating fish lure of claim 15 wherein the pre-programmed microprocessor is pre-programmed to effect an intermittent operation of the vibrator to effect an intermittent movement of the lure body component to simulate a healthy organism.

30. The vibrating fish lure of claim 15 wherein the pre-programmed microprocessor is pre-programmed to effect an intermittent operation of the vibrator to effect an intermittent movement of the lure body component to simulate of a distressed, diseased or dying organism.

31. A vibrating fishing lure, comprising in combination:
a hooking means;
a lure body component;
an electronic circuit board with a pre-programmed microprocessor and a vibrator integral thereto configured for effecting an intermittent movement of the lure body component, wherein the pre-programmed microprocessor is pre-programmed to effect an intermittent operation of the vibrator to effect an intermittent movement of the lure body component;
a power source to provide power to the electronic circuit board;
an on-off switch for turning the power source on and off; and
a containment component having the electronic circuit board, a first portion of the hooking means, the power source and the on-off switch contained in an internal waterproof portion therein, wherein the containment component is adhered to and contained within the lure body component to assist in intermittent movement of the lure body component.
